(19) United States
(12) Patent Application Publication
(10) Pub. No.: US 2017/0095097 A1
(43) Pub. Date: Apr. 6, 2017

(54) Single-use plate covered by paper towel is to absorb the grease of food

(71) Applicant: Fu Hwang, Milpitas, CA (US)

(72) Inventor: Fu Hwang, Milpitas, CA (US)

(21) Appl. No.: 14/873,219

(22) Filed: Oct. 2, 2015

(51) Int. Cl. A47G 19/02; B32B 3/08; B32B 27/10; B32B 29/00; B32B 7/12; B32B 5/18

(52) U.S. Cl. CPC A47G 19/02; B32B 7/12; B32B 5/18; B32B 27/10; B32B 29/005; B32B 29/007; B32B 3/08; B32B 2250/02; B32B 2255/24; B32B 2307/726

(57) ABSTRACT

An absorbent paper tissue (2) is attached to a single-use plate (1) with non-toxic wax or glue.

### CROSS-REFERENCE TO RELATED APPLICATIONS

Not Applicable.

### STATEMENT REGARDING FEDERALLY SPONSORED RESEARCH OR DEVELOPMENT (IF APPLICABLE)

Not Applicable.

### REFERENCE TO SEQUENCE LISTING, A TABLE, OR A COMPUTER PROGRAM LISTING COMPACT DISC APPENDIX (IF APPLICABLE)

Not Applicable.

### BACKGROUND OF THE INVENTION

The purpose of the plate is to cut down on grease intake from food. Food that is too greasy is unhealthy as well as messy.

### BRIEF SUMMARY OF THE INVENTION

A single-use plate covered by paper towel is to absorb the grease of food. Allows for healthier food habits and makes eating greasy foods less inconvenient and messy.

### BRIEF DESCRIPTION OF THE SEVERAL VIEWS OF THE DRAWING

FIG. 1 is the top-view of the plate.

FIG. 2 is the side view of the plate.

### DETAILED DESCRIPTION OF THE INVENTION

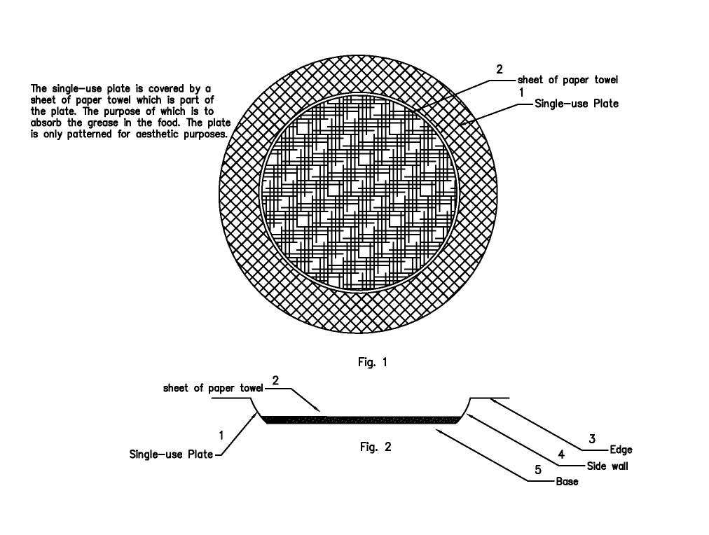

In FIG. 1, the single-use plate 1 is covered with a sheet of paper towel or soft tissue 2, the purpose of which is to absorb the grease of food. The paper towel is integrated with the single-use plate with some non-toxic glue or wax. In reference to FIG. 2 the paper towel can cover the base 5, or whole plate, including edge 3, side wall 4, and base 5, or in between (including base and side wall).

1. A paper towel is glued or attached to wax to a single-use plate to absorb the grease of food where:
the single-use plate is a plate made of paper, foam, or plastics and the paper towel is the soft paper tissue thick enough to absorb the food grease is integrated with the plate to cover the base, the whole plate, or some point in between.
